(19) United States
(12) Patent Application Publication
(10) Pub. No.: US 2018/0362314 A1
(43) Pub. Date: Dec. 20, 2018

(54) TRIM REMOVAL TOOL

(71) Applicant: Restore Eaze Tools, LLC, St. Louis, MO (US)

(72) Inventors: Quentin Sandusky, St. Louis, MO (US); Thomas McKenney, St. Louis, MO (US)

(73) Assignee: Restore Eaze Tools, LLC, St. Louis, MO (US)

(21) Appl. No.: 15/624,732

(22) Filed: Jun. 16, 2017

Related U.S. Application Data
(60) Provisional application No. 62/351,319, filed on Jun. 17, 2016.

(51) Int. Cl. B66F 15/00; B25C 11/00; B25G 1/10

(52) U.S. Cl. CPC B66F 15/00; B25G 1/102; B25C 11/00

(57) ABSTRACT

A pry and torque tool has a head extending from the distal section of an elongated shaft which has a bend in a section that is proximal to a handle. The elongated shaft extends from the proximal section through the center section to the distal section. The center section and distal section have a common longitudinal axis, and the proximal section's longitudinal axis obliquely intersects the common longitudinal axis. These shaft axes are within a central dividing plane. The handle's longitudinal axis is substantially perpendicular to the central plane, and the head's longitudinal axis and intersects with the proximal section's longitudinal axis. The bend in the shaft results in the handle's longitudinal axis being transversely offset from the common longitudinal axis toward the backside of the elongated shaft.

### CROSS-REFERENCE TO RELATED APPLICATIONS

This application claims priority from U.S. Provisional Patent Applicant No. 62/351,319, filed on Jun. 17, 2016, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present invention relates to a hand held trim removal tool, and more particularly to a pry tool with a handle at one end of an elongated staff.

### Related Art

Removing base or crown trim is a task required as a prerequisite for a number of larger construction, remodeling, and remediation tasks. These tasks include repainting wall surfaces, remodeling projects, and other types of remediation and demolition work.

Removing trim is a task that has primarily been performed in a kneeling position for base styles of trim, and a ladder for crown styles of trim. Traditionally, to remove the trim, a handheld putty knife or similar short-handled tool is used; the blade of the knife is inserted between the trim and its mounting surface and a reciprocating forward/backward prying motion of the straight handle is used to further pull the trim away from the mounting surface. Even when the knife has an extended shaft and handle, the currently known tools still have a handle that is aligned with the shaft so the forward/backward motion remains the primary method for separating the trim from the wall, and this motion is relatively inefficient and time consuming. When removing cove base trim, many times the trim is pulled by hand which can cause the top layer of the wall surface (drywall) to be pulled along with the cove base, and rip way from its main structure, causing cosmetic damage to the mounting surface, which must be repaired.

Since the gripping design of a putty knife or similar instrument has the handle aligned with the tool head, it provides only limited leverage potential. Even with an elongated shaft, the inefficient motion and time consuming action imposes a greater strain on the user, especially with repetitive use, and this repetitive use is magnified when larger jobs are involved, such as multiple rooms or large venues. It would be beneficial to have an elongated shaft with a handle that can provide a torque around the longitudinal axis of the tool head as compared to the current handles that only provide the reciprocating back and forth prying motion. Since the intended use of the tool is to remove trim while reducing damage to the mounting surface (i.e., wall) or to the trim itself by reducing breakage, current extended handles and tool heads that are used for demolition work are not satisfactory for work in which the goal is to minimize wall damage and trim breakage. Accordingly, there remains a need for an improved combination of a handle and tool head that can be used with an extended shaft to reduce the effort required to remove trim while also reducing the damage to the mounting surface and the trim.

### BRIEF DESCRIPTION OF THE DRAWINGS

The present invention will become more fully understood from the detailed description below and the accompanying drawings.

FIGS. 1A and 1B are back and side views of the tool with a t-shaped handle.

FIG. 1C is a perspective view of the tool with a t-shaped handle.

FIG. 2A is a perspective view of the tool with a delta-shaped handle.

FIG. 2B is a back view of the tool with a delta-shaped handle.

FIG. 2C is a side view of the tool with a delta-shaped handle.

FIGS. 3A and 3B are back and side detail views of a tool head.

FIGS. 4A and 4B are back and side views of an alternative tool head.

FIG. 5A is a back view of the tool with an alternative head embodiment.

FIG. 5B is a perspective detail view of the head shown in FIG. 5A.

FIG. 6A is a perspective view of a detachably mounted handle.

FIG. 6B is a side view of a permanently mounted handle.

FIG. 7 is a perspective view of an alternative head with a foot tab.

### DETAILED DESCRIPTION OF THE PREFERRED EMBODIMENTS

The following description of the preferred embodiment(s) is merely exemplary in nature and is in no way intended to limit the invention, its application, or uses.

Generally, the present invention is a trim removal device with a flat head of such rigidity and width, so as to allow the application of a torsional force, created by a twisting action of a t-handle, transmitted through a shaft of sufficient length, so as to allow the application of the force from a standing position, with a handle of sufficient design, such as, but not limited to a T-shaped design, so as to allow the most easily delivered method of manually applying the twisting action, by effectively transferring the torsional force provided by the user, to a head which is of sufficient width to allow effective leverage between the two sides of the blade, with each side-edge alternating its role as a fulcrum to the leveraging action of the opposite side, so as to more easily disengage a variety of trim from its mounting surface, by applying the head of the device between the void between the targeted trim, and its mounting surface, such as, but not limited to drywall, with the purpose of easing the task of trim removal, and reducing damage to the mounting surface, which is an inherent problem with traditional and current methods of trim removal. With the interchangeable heads and telescoping shaft described below, the trim removal tool can be used for base trim or molding, base coping trim, crown molding trim, chair rail molding trim or any other type of trim fixed to a wall.

The improved trim removal tool of the present invention is designed to minimize or entirely remove the shortcomings from the current methods of removing crown or base trim. The trim removal tool has a special head, designed to allow the user to apply the forces necessary to separate the trim from its mounting surface, by using a torsional force, which is created by a twisting action of the device. The trim removal tool effectively transfers the twisting action provided by the user, to a head which is of sufficient width to allow effective leverage between the two sides of the blade, with each side alternating its role as a fulcrum to the leveraging action of the opposite side. The trim removal tool has a shaft of sufficient length and a handle of sufficient length and design so as to allow the application of the twisting action from a standing position.

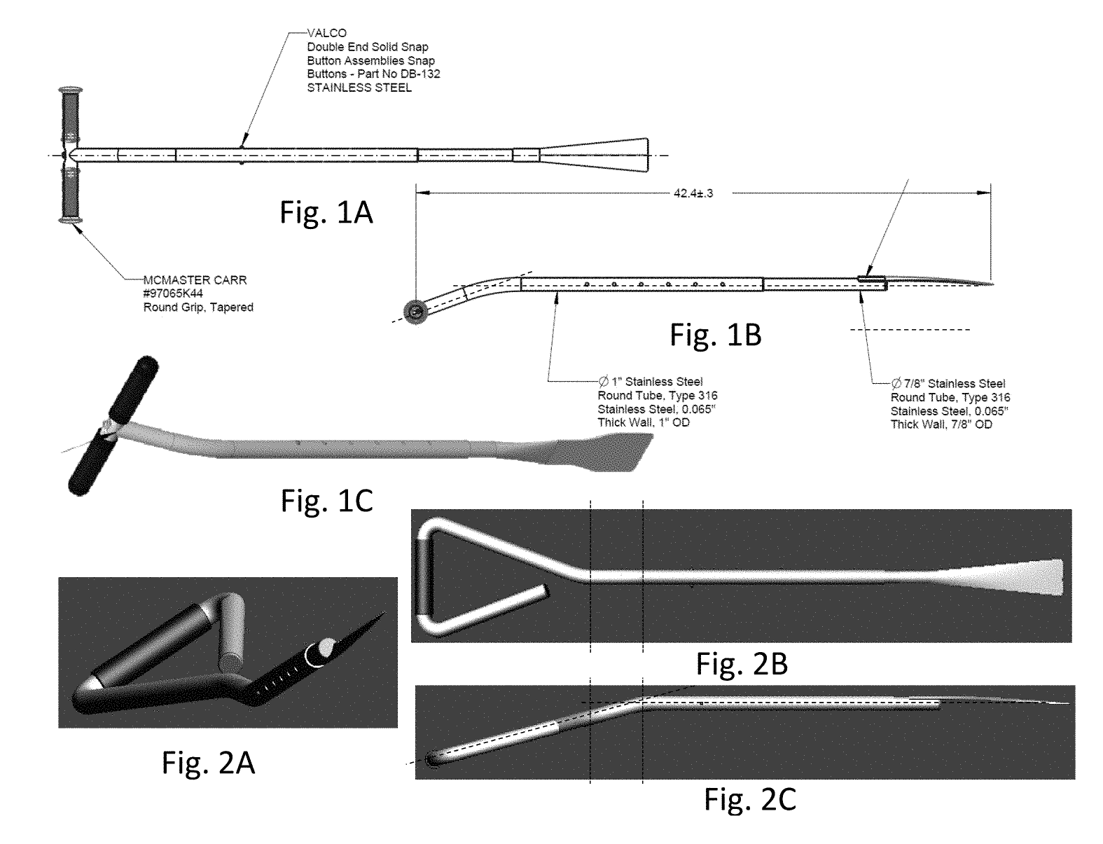

The handle shape can be a T-shaped design or a delta-shaped (Δ) design as shown in the FIGS. 1 and 2 or may be any other shape that has a longitudinal axis that is substantially perpendicular to the longitudinal axis of the tool's head. With the preferred bent shaft design (discussed below), the handle's longitudinal axis is perpendicular to the shaft's central plane and intersects with the longitudinal axis of the shaft's proximal section. The perpendicular relationship of the handle to the tool's longitudinal axis and the shaft's central plane provides a moment arm that allows the user to apply a torque around the head's longitudinal axis for a more efficient separation of the trim away from the wall. The handle itself may also be removable in some embodiments as shown in FIG. 7. A removable handle preferably has a pin that holds the T-shaped handle within the end of the elongated tubular shaft. When the pin is removed, the T-shaped handle can be removed from the shaft. This allows a person to easily switch the shape of the handle or remove the handle all together should a person need to get into a tight area such as tight corners. Also, having a removable handle offers a benefit when shipping the tool whereas the entire unit can fit in a smaller carton when the handle is detached.

The shaft preferably has a bend in it between the proximal section and the central section, and the central and distal sections of the shaft preferably have a common longitudinal axis that is substantially parallel to the longitudinal axis of the tool's head. The parallel longitudinal axes can be aligned with each other or can be transversely offset as shown in the drawings. The tool head is preferably connected to the front side of the shaft's distal end. This location of the tool head and the bend in the shaft allows a user to place the shaft's center and distal sections and the head flush with the wall so that the leading edge of the head is nearly aligned with the plane of the wall. Specifically, the front side of the shaft's distal section can be placed flush to the wall when the tool is initially used to create or follow the space between the wall and the trim so having the head extending from the front side of the distal section allows the head to be aligned with the wall and the space. The bend in the shaft at the proximal section provides for an offset of the handle away from the wall when the distal section is flush with the wall which provides a space between the user's hands on the tool's handle grips and the wall, thereby preventing any interference in aligning both the distal section and the tool's head with the plane of the wall. The shaft may also have telescoped sections to adjust the length for users of different height and different reaches required for trim that may be located along the floor or the ceiling, however a shaft having a fixed length is also applicable to the tool described herein.

The pry and torque tool according to the present invention has the elongated shaft, the handle, and the head. The elongated shaft extends from the proximal section through the center section to the distal section. The center section and distal section have a common longitudinal axis, and the proximal section's longitudinal axis obliquely intersects the common longitudinal axis. These shaft axes are within a central dividing plane.

The handle is connected to and extends from the proximal section of the elongated shaft as shown in FIG. 1. As indicated above, the handle's longitudinal axis is substantially perpendicular to the central plane and the head's longitudinal axis and intersects with the proximal section's longitudinal axis. The bend in the shaft results in the handle's longitudinal axis being transversely offset from the common longitudinal axis toward the backside of the elongated shaft. The center portion of the handle is preferably located within the shaft's central plane.

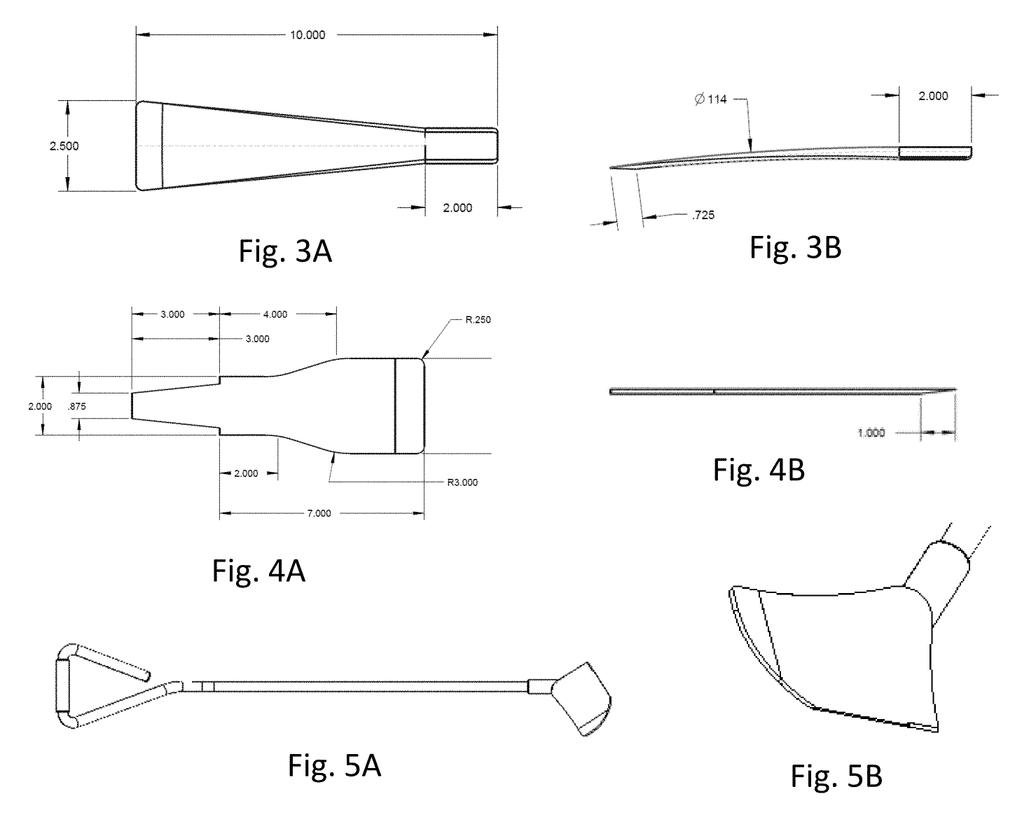

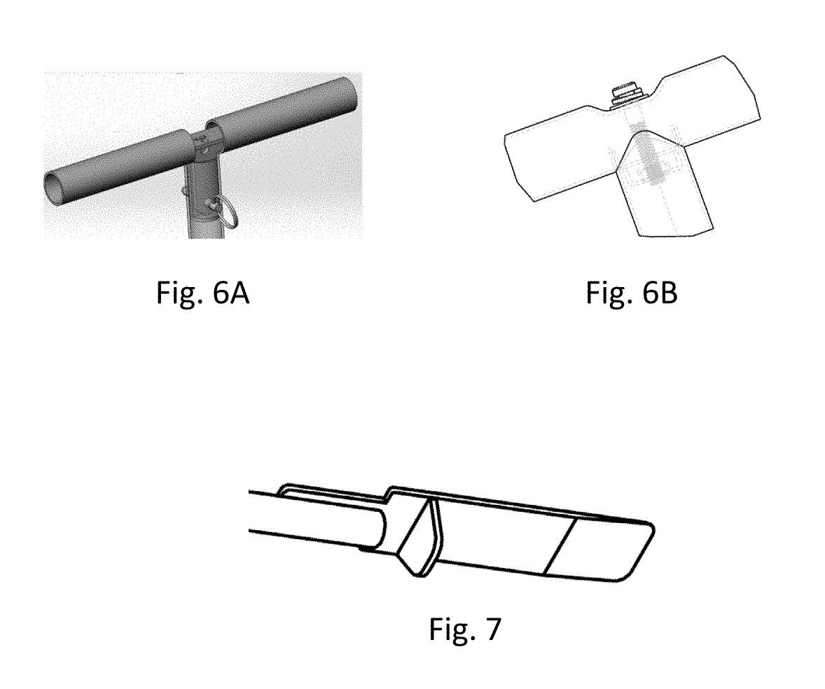

The head has a proximal end connected to the front side of the distal section. The head has a single prong extending longitudinally, shown in FIGS. 3, 4 and 5, and flaring laterally from its narrowest width at the proximal end to a broader width at the leading edge that extends along the head's flared distal end. The flared distal end has a lateral axis substantially parallel to the handle's longitudinal axis, and the flared distal end has a transverse location between the shaft's front side and backside inclusive. Accordingly, the single prong of the head can be completely flat, as shown in FIG. 4B, or it may have some curvature that is preferably no greater than the distal section's transverse thickness between its front side and backside, as shown in FIGS. 3B and 5B. It will be appreciated that the single prong can be straight or bend transversely away from the front side of the distal section and toward the backside, and the flared distal end may have a transverse location between the front side and the first longitudinal axis inclusive.

Since the tool is different from most elongated pry bars which are designed for demolition and are solid or have very thick wall sections, the tool of the present invention is designed to provide a rotational torque as well as a prying action to minimize damage to the wall and avoid breaking the trim. Accordingly, the tool does not need to be solid or have thick walls. Therefore, to reduce the weight of the tool and reduce fatigue on the user, the elongated shaft is preferably comprised of a thin-walled tube with a tube wall thickness that is less than one fifth of the tube diameter. Additionally, as indicated above, the tubular shaft sections can be formed as telescoping sections with a coupler between the telescoping sections. Preferably, the distal section has a smaller outer diameter than the inner diameter of the shaft's proximal and center sections which allows it to telescope into the interior of the shaft's proximal and center sections.

As shown in the FIG. 1B and 2A, the telescoping tube sections of the shaft can be locked in place using a push-button detent that is connected to an inner concentric tube section and which extends through a hole in a series of holes spaced along the outer concentric tube section. Examples of push-button detent couplings are also disclosed in U.S. Pat. No. 3,347,575 and U.S. Des. Pat. No. 482,752 which are incorporated by reference herein. An alternative coupling between the telescopic tube sections of the shaft could be compression coupling as particularly described in U.S. Pat. No. 5,649,780 which is incorporated by reference herein. Alternative types of adjustable-length poles with concentric tubular sections are described in U.S. Pat. No. 6,027,087 and US Pat. Pub. No. 2010/0310306 which are hereby incorporated by reference herein. Another type of compression coupling and examples of its components are particularly described in U.S. Pat. No. 3,545,794 which is incorporated by reference herein.

The present invention also allows for interchangeable heads that may take multiple embodiments as depicted in FIGS. 3, 4 and 5. Generally, the heads have a width at the proximal end substantially equal to the transverse thickness of the distal section of the elongated shaft, and the width of the flared distal end is greater than at least twice the width of the distal section. In one embodiment shown in FIG. 3, the head's single prong may be elongated such that its longitudinal length is at least five (5) times as long as the width of the head's proximal end. In another embodiment, the head's single prong may be broadened such that it has a lateral width approximately equal to the longitudinal length. The elongated prong can have a rectangular or trapezoidal shape with a sharpened leading edge substantially parallel to the handle's longitudinal axis and may be flat or have a concave front surface. As explained below, the broadened prong is designed to work best with cove base trim, and it has a generally parallelogram-shape with a sharpened leading edge and a concave front surface, as in FIG. 5.

The head design for removing cove base trim shown in FIG. 5 preferably has a scooped, concave surface that is designed to deliver a leveraging action as the head is pulled parallel to the void between the cove base trim and its mounting surface. The head sufficiently disengages the cove base trim from the wall's drywall surface or other mounting surface with an angle of sufficient deviation so as to cause the cove base trim to easily separate from the mounting surface. The leading edge is sharpened to create a cutting edge that effectively severs the cove base trim from its mounting surface. By severing the adhesive used to mount the cove base trim to its mounting surface, the head facilitates the expedient removal of the cove base trim with a less damaging outcome to the mounting surface than current methods. Cove base trim is many times made of a rubber or vinyl composition.

In another embodiment depicted in FIG. 7, the head also has a foot tab extending from the proximate end of the head. In operation, the foot tab allows a person to use the pressure from their foot to push the head of the tool down and wedge it between the baseboard and the wallboard. The tab may vary in size but is preferably proportionate to the size of the head and may be affixed to any of the aforementioned head shapes or other head shapes. The tab extends substantially perpendicular from the backside of the head and preferably spans entire distance between the side edges of the head. The tab preferably extends from the head a distance that is approximately equal to or less than the width of the leading edge of the head. In some embodiments the tab is c-shaped, as shown in the figures, but the tab may also be any other similar shapes that allow a person to apply pressure with their foot. The tab is shown mounted to the elongated rectangular head, and it will be appreciated that this tab could also be used with a broadened head.

In another embodiment not shown, the shaft has a bend between the central section and the distal section of the shaft, and the distal section of the shaft preferably has a common longitudinal axis that is substantially parallel to the longitudinal axis of the tool's head. The location of the bend in the shaft in this area allows a user to utilize the bend as a fulcrum, to expand the option of movement offered by the present invention, to dislodge the trim from its mounting surface by using a leveraging forward/backward motion, with the mounting surface acting as a base for the fulcrum created by the bend to rest upon. This embodiment of the shaft is shown with an elongated rectangular head, and it will be appreciated that this shaft could also be used with a broadened head.

The trim removal tool provides a less destructive method for removing base or crown trim, than current devices and long-handled pry bars, (which allows for the delivery of a leveraging action, perpendicular to the user, that applies its pulling action to the top of the trim, pulling the trim away from its mounting surface at a slant) by providing a device, which delivers an alternating leveraging action, that applies its pulling action along the left and right edges of the head of the device, resulting in an evenly distributed action, that keeps the base trim parallel to its mounting surface. This improvement accomplishes its goal to remove trim, with less potential damage to the top portion of the trim, its mounting surface, and any adjacent floor, wall, or ceiling surfaces that connect to the primary mounting surface, than current methods.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. According to the alternative versions of the tool features described above, the trim removal tool more easily disengages a variety of crown and base trim from its mounting surface, by applying the head of the device between the void between the targeted trim, and its mounting surface. The trim removal tool is designed to ease the task of trim removal, and reduce damage to trim and the mounting surface. Thus, the breadth and scope of the present invention should not be limited by any of the above-described exemplary embodiments, but should be defined only in accordance with the following claims appended hereto and their equivalents.

What is claimed is:

1. A pry and torque tool for removing trim from a wall in a nondestructive and efficient manner, comprising:
an elongated shaft extending from a proximal section through a center section to a distal section, wherein the center section has a common first longitudinal axis with at least one of the proximal section and the distal section, wherein at least one of the proximal section and the distal section has a second longitudinal axis obliquely intersecting the first longitudinal axis, wherein the first longitudinal axis and the second longitudinal axis are within a central dividing plane, and wherein the distal section has a transverse thickness between its front side and backside;
a handle connected to and extending from the proximal section of the elongated shaft, wherein the handle has a third longitudinal axis substantially perpendicular to the central plane and intersecting with at least one of the first longitudinal axis and the second longitudinal axis, and wherein a center portion of the handle is within the central plane; and
a head having a proximal end connected to the front side of the distal section, wherein the head is comprised of a single prong extending longitudinally and flaring laterally from a first width at the proximal end to a second width at a leading edge extending along a flared distal end, wherein the flared distal end has a lateral axis substantially parallel to the third longitudinal axis of the handle, and wherein the flared distal end has a transverse location between the front side and the backside inclusive.

2. The tool of claim 1, wherein the single prong bends transversely away from the front side of the distal section and toward the backside, wherein the flared distal end has a transverse location between the front side and the first longitudinal axis inclusive.

3. The tool of claim 1, wherein the head has a longitudinal axis parallel to and transversely offset from the first longitudinal axis of the shaft, wherein the elongated shaft is comprised of a thin-walled tube, and wherein the tube wall thickness is less than one fifth of the tube diameter.

4. The tool of claim 3, wherein the elongated shaft is comprised of telescoping sections and a coupler between the telescoping sections, wherein a first telescoping section is comprised of the proximal section and the center section, and wherein a second telescoping section is comprised of the distal section.

5. The tool of claim 1, wherein the first width of the head's proximal end is substantially equal to the transverse thickness of the distal section of the elongated shaft, wherein the second width of the flared distal end is greater than at least twice the width of the distal section.

6. The tool of claim 5, wherein the head is removably connected to the elongated shaft, wherein the single prong for a first removable head is comprised of an elongated prong, wherein a longitudinal length of the elongated prong is at least five times as long as the first width of the head's proximal end, wherein the single prong for a second removable head is comprised of a broadened prong, and wherein the broadened prong has a lateral width approximately equal to a longitudinal length.

7. The tool of claim 6, wherein the elongated prong is further comprised of a trapezoidal shape with a sharpened leading edge substantially parallel to the third longitudinal axis of the handle and a concave front surface, wherein the broadened prong is further comprised of a generally parallelogram-shaped with a sharpened leading edge and a concave front surface.

8. The tool of claim 1, further comprised of a tab connected to the proximal end of the head, wherein the tab is comprised of a tab width substantially equal to the first width of the prong, wherein the tab extends a distance from the prong substantially perpendicular to the head, and wherein the distance is less than the second width at the flared distal end of the prong.

9. A pry and torque tool for removing trim from a wall in a nondestructive and efficient manner, comprising:
an elongated shaft extending from a proximal section through a center section to a distal section, wherein the center section has a common first longitudinal axis with at least one of the proximal section and the distal section, wherein at least one of the proximal section and the distal section has a second longitudinal axis obliquely intersecting the first longitudinal axis, wherein the first longitudinal axis and the second longitudinal axis are within a central dividing plane, wherein the distal section has a transverse thickness between its front side and backside, wherein the elongated shaft is comprised of telescoping sections and a coupler between the telescoping sections, wherein a first telescoping section is comprised of the proximal section and the center section, and wherein a second telescoping section is comprised of the distal section;
a handle connected to and extending from the proximal section of the elongated shaft, wherein the handle has a third longitudinal axis substantially perpendicular to the central plane and intersecting with at least one of the first longitudinal axis and the second longitudinal axis, and wherein a center portion of the handle is within the central plane; and
a head having a proximal end connected to the front side of the distal section, wherein the head is comprised of a single prong extending longitudinally and flaring laterally from a first width at the proximal end to a second width at a leading edge extending along a flared distal end, wherein the flared distal end has a lateral axis substantially parallel to the third longitudinal axis of the handle, wherein the flared distal end has a transverse location between the front side and the backside inclusive, wherein the single prong bends transversely away from the front side of the distal section and toward the backside, and wherein the flared distal end has a transverse location between the front side and the first longitudinal axis inclusive.

10. The tool of claim 9, further comprising a tab connected to the proximal end of the head, wherein the tab is comprised of a tab width substantially equal to the first width of the prong, wherein the tab extends a distance from the prong substantially perpendicular to the head, and wherein the distance is less than the second width at the flared distal end of the prong.

11. The tool of claim 9, wherein the first width of the head's proximal end is substantially equal to the transverse thickness of the distal section of the elongated shaft, wherein the second width of the flared distal end is greater than at least twice the width of the distal section.

12. The tool of claim 11, wherein the head is removably connected to the elongated shaft, wherein the single prong for a first removable head is comprised of an elongated prong, wherein a longitudinal length of the elongated prong is at least five times as long as the first width of the head's proximal end, wherein the single prong for a second removable head is comprised of a broadened prong, and wherein the broadened prong has a lateral width approximately equal to a longitudinal length.

13. The tool of claim 12, wherein the elongated prong is further comprised of a trapezoidal shape with a sharpened leading edge substantially parallel to the third longitudinal axis of the handle and a concave front surface, wherein the broadened prong is further comprised of a generally parallelogram-shaped with a sharpened leading edge and a concave front surface.

14. The tool of claim 12, wherein the single prong is further comprised of a first-side edge and a second-side edge extending on opposite edges of the proximal end and the leading edge, wherein the prong engages the trim and the wall in a plurality of positions, wherein in a first position the first-side edge engages the trim and the second-side engages the wall, wherein in a second position the first-side edge engages the wall and the second-side engages the trim.

15. The tool of claim 14, wherein the first-side edge and the second-side edge respectively alter between at least one of a fulcrum and a lever in the first position and second position.

16. A pry and torque tool for removing trim from a wall in a nondestructive and efficient manner, comprising:
an elongated shaft extending from a proximal section through a center section to a distal section, wherein the center section has a common first longitudinal axis with at least one of the proximal section and the distal section, wherein at least one of the proximal section and the distal section has a second longitudinal axis obliquely intersecting the first longitudinal axis, wherein the first longitudinal axis and the second longitudinal axis are within a central dividing plane, and wherein the distal section has a transverse thickness between its front side and backside;
a handle connected to and extending from the proximal section of the elongated shaft, wherein the handle has a third longitudinal axis substantially perpendicular to the central plane and intersecting with at least one of the first longitudinal axis and the second longitudinal axis, and wherein a center portion of the handle is within the central plane;
a head having a proximal end connected to the front side of the distal section, wherein the head is comprised of a single prong extending longitudinally to a leading edge having a width extending along a distal end, and wherein the single prong is further comprised of a trapezoidal shape with a sharpened leading edge substantially parallel to the third longitudinal axis of the handle; and
a tab connected to the proximal end of the head, wherein the tab is comprised of a tab width substantially equal to the width of the prong, wherein the tab extends from the prong substantially perpendicular to the head.

17. The tool of claim 16, wherein the head flares laterally from a first width at the proximal end to a second width at the distal end.

18. The tool of claim 16, wherein the handle is removably connected to the proximal section of the elongated shaft.

19. The tool of claim 16, wherein the handle is permanently affixed to the proximal section of the elongated shaft.

20. The tool of claim 16, wherein the elongated shaft is comprised of telescoping sections and a coupler between the telescoping sections, wherein a first telescoping section is comprised of the proximal section and the center section, and wherein a second telescoping section is comprised of the distal section.
